(19) United States
(12) Patent Application Publication
(10) Pub. No.: US 2015/0274036 A1
(43) Pub. Date: Oct. 1, 2015

(54) Smart phone alert system for abandoned infants behind in seats vehicle

(71) Applicants: Eli Arad, Tzofit (IL); Nissim Zur, Givataim (IL)

(72) Inventors: Eli Arad, Tzofit (IL); Nissim Zur, Givataim (IL)

(21) Appl. No.: 14/672,258

(22) Filed: Mar. 30, 2015

Related U.S. Application Data
(60) Provisional application No. 61/972,534, filed on Mar. 31, 2014.

(51) Int. Cl. B60N 2/00

(52) U.S. Cl. CPC B60N 2/002

(57) ABSTRACT

A monitor for detecting a potential abandonment of an infant in a seat of car; the monitor comprises: a distance sensor that is configured to detect a distance between the distance sensor and a target; wherein the target is the seat of the car when the infant is not seated in the seat; wherein the target is the infant when the infant is seated in the seat; and a controller that is configured to (a) receive, from the distance sensor, distance information about the distance between the distance monitor and the target, (b) receive potential departure information indicative of a potential departure, from the car, of a driver of the car; (c) determine, in response to the distance information and the potential departure information, whether the potential abandonment occurred; and (d) response to the determining of whether the potential abandonment occurred.

### RELATED APPLICATION

This patent application claims the priority of U.S. Provisional Patent Ser. No. 61/972,534 filing date Mar. 31, 2014 which is incorporated herein by reference in its entirety.

### TECHNICAL FIELD

This document relates generally to a warning system for detecting the presence of an occupant seat in a vehicle, and particularly, but not by way of limitation, to a warning system for sensing a child left in a seat in a vehicle.

### BACKGROUND

Bringing home new baby is usually a joyful occasion. The addition of new family member, however, can be stressful on a family as the presence of a new family member that changes the family dynamics. Also, with a new baby in the home, parents or caretakers are often seriously on a sleep deprived due to an infant's irregular feeding and sleeping schedules. A long period of sleep deprivation can have a significant effect on a person's memory. Tragically, every year infants die or are seriously injured due a driver forgetting that an infant is in the back seat of a car, and leaving the vehicle for a long period of time, such as while they are working. If the weather is either very hot or very cold, the infant can perish prior to anyone becoming aware of the dangerous situation. An examination of media reports, about the 605 child vehicular heatstroke deaths for an fourteen year period (1998 through 2013) shows the following circumstances:

52%—child “forgotten” by caregiver (315 Children)
29%—child playing in unattended vehicle (175)
18%—child intentionally left in vehicle by adult (108)
1%—circumstances unknown (6)

Although not all of these children were infants left behind in car's seats; some were children that climbed into parked cars but then couldn't get out on their own.

A system for detecting whether a child car seat harness is locked is discussed in U.S. Pat. No. 5,581,234 to Emery et al., entitled INFANT VEHICLE SEAT ALARMSYSTEM, which is incorporated herein by reference in its entirety.

A system for detecting whether a child has been left behind in a school bus is discussed in U.S. Pat. No. 5,243,323 to Rogers, entitled SCHOOL BUS ALARMSYSTEM, which is incorporated herein by reference in its entirety.

A system for preventing children from becoming inadvertently locked within a vehicle is discussed in U.S. Pat. No. 5,793,291 to Thornton, entitled CHILDALERT SYSTEM FOR AUTOMOBILES, which is incorporated herein by reference in its entirety. The system uses a motion detector to detect the presence of a child or pet within a locked vehicle. While this system provides some advance child's sensing devices, particularly in the case of older children that may inadvertently lock them in a vehicle while playing, it fails to protect children who have been left asleep in their child seats and are not capable of sufficient activity to set off a motion detector. Such infants may continue sleeping and may become dehydrated and comatose without ever waking, and therefore, they may not be detected by a motion detector.

A system for preventing children from being left behind in an infant car seat is discussed in U.S. Pat. No. 5,949,340 and U.S. Pat. No. 6,104,293 to Rossi, each entitled WARNING SYSTEM FOR DETECTING PRESENCE OF A CHILD IN AN INFANT CAR SEAT, and each of which is incorporated by reference herein in its entirety. This system generates a warning when an infant is present and the vehicle ignition system has been turned from “on” to “off.” Detecting the state of an automotive ignition system, however, may be difficult to implement. Such ignition detection may require complicated electronic components, which may be different for different automobile models. As a result, such a system may be difficult to bundle with an infant car seat, which is often, but not always, purchased separately from the vehicle. Therefore, such a system may not gain the widespread consumer acceptance that is desired to avoid the potential tragedy that may result from leaving a child behind in an infant car seat. The present inventors have recognized, therefore, that there is an unmet need for an improved system for avoiding such tragedy.

### SUMMARY

There may be provided a child's sensing device and methods for reducing the likelihood of leaving an unattended child behind in an infant/child seat in a vehicle.

A first illustrative example includes a child's sensing device for detecting a child left in an unattended child car seat in a vehicle. In this example, the system comprises a proximity distance sensor sensing the distance between the sensor and the first object blocking the IR beam.

The sensor sends a modulated Infra-red (“IR) beam and detects its returns. The distance is calculated by the sensor, This distance information is sent to microcontroller (“MCU”) over I2C bus, inside the child's sensing device.

When there is no child in the seat, the distance is stored inside the child's sensing device flash. When a child is placed in the seat, The IR beam is blocked by the body of the child and a shorter distance is reported to the MCU.

The MCU calculates the difference between empty seats, as distance to seat's back to current occupant seat, as child's stomach and if the difference is been decided as child's width body, a unique wireless message is sent to the driver's smart phone to activate the Baby Guardian application automatically.

In the driver's smart phone there is an application, Baby Guardian detects that unique wireless message and triggers itself to an active state. While doing that, the system reports the driver, by a human voice that the child's sensing device is working OK and the child is monitored.

The unique wireless message contains also location base ID and child's sensing device level of it battery. So several child's sensing device can be on same car, and can be many smart phone Baby Guardians that can detect that in parallel.

If child's sensing device battery level of the child's sensing device reported as too low, a unique message is display and played to the driver,

When the child is removed from the car seat. The child's sensing device detects it, by longer distance to car's seat, as an empty seat, and sends a wireless command to driver's smart phone application, Baby Guardians, to become: “non active”. The battery of child's sensing device is sent again to alert the driver for low level.

If the driver with his smart phone, walks away from the car, without the child, the application on the smart phone, alerts the driver by alarm sound, voice messages, and electronic message as SMS, Email and automatically phone call. The distance is detected by RSSI by the smart phone application, Baby Guardians, to the child's sensing device.

It is possible to install a Baby Guardians child's sensing device near the driver seat, to detect when the driver walks out and forgets his smart phone in the car. In this mode, the Baby Guardians application in the smart phone will send an alert message to 911 with GPS location after pre define time.

The driver seat Baby Guardians child's sensing device will report the Baby Guardians in the smart phone, the empty driver seat, since the driver did not come back to his seat and forgot his phone behind.

The child's sensing device detects also the ongoing wireless connection to the driver's smart phone application, Baby Guardians. And if the driver's smart phone is closed due to low battery level, and therefore the wireless link from the application Baby Guardians to child's sensing device is broken, the child's sensing device will sound an alert using its internal buzzer.

In “active” alert state, when the driver walks away leaving an unattended child behind in an infant/child seat in a vehicle. The driver can't disable the Baby Guardian application. The only way is to walk back to car and disable it by pressing a button on the child's sensing device itself or remove the child from the car seat.

The system of first example may include other variations. In one embodiment, the system may include a comparator circuit and a control circuit. The comparator circuit is coupled to the output of the distance detection sensor. The comparator circuit includes at least one of high and low distance detection thresholds. The comparator includes an output to provide a signal indicating whether the ambient vehicle distance detection is outside the acceptable range. The control circuit is coupled to the output of the comparator and the output of the child occupant sensor. The control circuit includes a timer to determine whether the child has been in the seat for a predetermined period of time at distance detection outside the acceptable range, and an output to provide a responsive alarm activation signal. The alarm is coupled to the output of the control circuit to provide an alarm responsive to the alarm activation signal.

In other variations, the system further comprises a driver's occupant sensor. The driver's occupant sensor includes an input to detect a driver in a driver's seat. The alarm is configured to provide a warning using information about whether the driver is present in the driver's seat. In these variations there is no need for smart phone. Child's sensing device is wirelessly communicates with driver's sensing device. When the driver gets out of the car, the child's sensing device starts to sound an alert sound to attract the driver's attention.

In other variations, the system further comprises a master child's sensing device integrated in car cigarette plug and child's sensing device near the child seat.

When the driver pulls out the car's keys, there is no power to the car cigarette plug and the child's sensing device near the child's seat starts to beep. In these variations there is no need for smart phone. Child's sensing device is wirelessly communicates with driver's cigarette plug sensing device. When the driver closes the car power, the child's sensing device starts to sound an alert to attract the driver attention. The child's sensing device is integrated in car cigarette plug and may have a disable button to disable its function in case the child is asleep and the driver has to press it before car power is “off”. In this case the driver is fully aware of the child in the seat, and unique wireless message is send to disable temporary the child's sensing device near the child.

In other variations, the system further comprises a master child's sensing device integrated into key fab and child's sensing device near the child's seat. This key fab acts exactly as the Baby Guardian application in smart phone.

In addition, in some embodiments discloses a method includes detection whether a child is present in a child car seat in a vehicle, detecting ambient smart phone distance detection, and providing an indication of whether a child is present in the child's car seat at ambient distance detection outside a predetermined range.

In other variations, the method includes providing an indication of whether a child is present in the child car seat at an ambient distance detection outside a predetermined range for a time period that exceeds a predetermined duration. In another embodiment, the method includes wirelessly communicating the indication to a remote location.

According to an embodiment of the invention there is provided a monitor for detecting a potential abandonment of an infant in a seat of car; the monitor may include a distance sensor that is configured to detect a distance between the distance sensor and a target; wherein the target is the seat of the car when the infant is not seated in the seat; wherein the target is the infant when the infant is seated in the seat; and a controller that is configured to (a) receive, from the distance sensor, distance information about the distance between the distance monitor and the target, (b) receive potential departure information indicative of a potential departure, from the car, of a driver of the car; (c) determine, in response to the distance information and the potential departure information, whether the potential abandonment occurred; and (d) response to the determining of whether the potential abandonment occurred.

The distance sensor comprises an infrared transmitter that is configured to transmit modulated infrared pulses towards the seat of the car and an infrared receiver that is configured to receive infrared signals from the target.

The potential departure information may be indicative of a power shut down of the car.

The potential departure information may be location information that may be indicative of a location of the driver.

The potential departure information may be provided by a driver seat sensor and may be indicative of a departure of a driver from the driver seat.

The monitor may include a battery and a battery sensor that may be configured to sense a state of the battery.

The transceiver may be configured to transmit to a user device an activation message that once received by the user device activates a child monitoring application.

The monitor wherein the controller may be arranged to respond to an occurrence of the potential abandonment by sending an alert to the user device.

The controller may be arranged to respond to an occurrence of the potential abandonment by sending an alert to the user device and to a remote party.

The controller may be arranged to monitor a state of communication between the monitor and a user device and to generate an alert when the communication breaks.

The monitor may include a housing and a code that once retrieved by a user device causes the user device to a download a child monitor application.

The transceiver may be configured to operate at a broadcast mode during which the transceiver periodically transmits status information that reflect the determining of whether the potential abandonment occurred; wherein the status information once received by a user device activates a child monitoring application, wherein the activation of the child monitoring application may be executed even if the user device did not pair with the monitor.

A system for detecting a potential abandonment of an infant in a seat of car, wherein the system may include a monitor and at least one additional sensor; wherein the monitor may include s: a distance sensor that may be configured to detect a distance between the distance sensor and a target; wherein the target may be the seat of the car when the infant may be not seated in the seat; wherein the target may be the infant when the infant may be seated in the seat; and a controller that may be configured to (a) receive, from the distance sensor, distance information about the distance between the distance monitor and the target, (b) receive potential departure information indicative of a potential departure, from the car, of a driver of the car; (c) determine, in response to the distance information and the potential departure information, whether the potential abandonment occurred; and (d) response to the determining of whether the potential abandonment occurred; wherein the at least one additional sensor may be selected of a group consisting of (a) a car power sensor that may be configured to detect a shutdown of the car; and (b) a driver seat sensor that may be configured to detect whether a driver sits in the driver seat.

The system wherein the car power sensor may be plugged in a cigarette plug of the car.

A method for detecting a potential abandonment of an infant in a seat of car; the method may include detecting, by a distance sensor, a distance between the distance sensor and a target; wherein the target may be the seat of the car when the infant may be not seated in the seat; wherein the target may be the infant when the infant may be seated in the seat; receiving, by a controller distance information about the distance between the distance monitor and the target; receiving, by the controller, potential departure information indicative of a potential departure, from the car, of a driver of the car; determining, by the controller and in response to the distance information and the potential departure information, whether the potential abandonment occurred; and (d) responding to the determining of whether the potential abandonment occurred

In addition, in some embodiments includes a method. In this example, the method includes detecting whether a child is present in a child car seat in a vehicle, detecting whether a driver is present in a driver's seat in the vehicle, and providing an indication of whether a child is present in the child's car seat when the driver leaves the driver's seat.

In other variations, the method includes wirelessly communicating the indication to a remote location. In one embodiment, the method includes car power off by car cigarette plug, with a master child's sensing device integrated inside.

Other aspects of the disclosed systems, devices, and methods will become apparent upon reading the following detailed description and viewing the drawings that form a part thereof.

### BRIEF DESCRIPTION OF THE DRAWINGS

In the drawings, which are offered by way of example, and not by way of limitation, and which are not necessarily drawn to scale, like numerals describe substantially similar components throughout the several views. Like numerals having different letter suffixes represent different instances of substantially similar components.

FIG. 1 illustrates generally an example of child's sensing device portions of a system sensing a child left behind in an infant seat front view according to an embodiment of the invention;

FIG. 2 illustrates generally an example of child's sensing device portions of a system sensing a child left behind in an infant seat rear view;

FIG. 3 illustrates generally an example of child's sensing device portions of a system sensing a child left behind in an infant seat front view with the proximity distance sensor windows;

FIG. 4 illustrates generally an example of child's sensing device portions of a system sensing a child left behind in an infant seat left side button view;

FIG. 5 illustrates generally an example of child's sensing device portions of a system sensing a child left behind in an infant seat front view;

FIG. 6 illustrates generally an example of child's sensing device portions of a system sensing a child left behind in an infant seat inside parts;

FIG. 7 illustrates generally an example of child's sensing device portions of a system sensing a child left behind in an infant battery cavity and its cover;

FIG. 8 illustrates generally an example of the inner PCB component side inside of child's sensing device;

FIG. 9 illustrates generally an example of the inner PCB mechanical side inside of child's sensing device;

FIG. 10 is illustrates generally an example of child's sensing device installed in minibus, detected child left behind in a bus seat; If the child's sensing device detects a distance longer than bus seats the system marks that as an occupied seat;

FIG. 11 is illustrates generally an example of child's sensing device installed in car; The distance detected when there is no child in seat is the base to detect seat occupied later;

FIG. 12 is illustrates generally an example of child's sensing device installed in a car, detected the distance to a child's seating in child seat; The distance difference between test in FIG. 11 and FIG. 12 is the base to automatically system activation or deactivation;

FIGS. 13A and 13B illustrate schematic electronic diagram of the child's sensing device; The same schematics is used in the child's sensing device installed in front of the child's seat in car, in mini bus, in a driver's seat detector, in car cigarette plug or in key fab

### DETAILED DESCRIPTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that the embodiments may be combined, or that other embodiments may be utilized and that structural, logical and electrical changes may be made without departing from the spirit and scope of the present invention. The following detailed description is, therefore, not to be taken in a limiting sense, and the scope of the present invention is defined by the appended claims and their equivalents. In this document, the terms “a” or “an” are used, as is common in patent documents, to include one or more than one. Furthermore, all publications, patents, and patent documents referred to in this document are incorporated by reference herein in their entirety, as though individually incorporated by reference.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method.

Any reference in the specification to a system should be applied mutatis mutandis to a method that may be executed by the system.

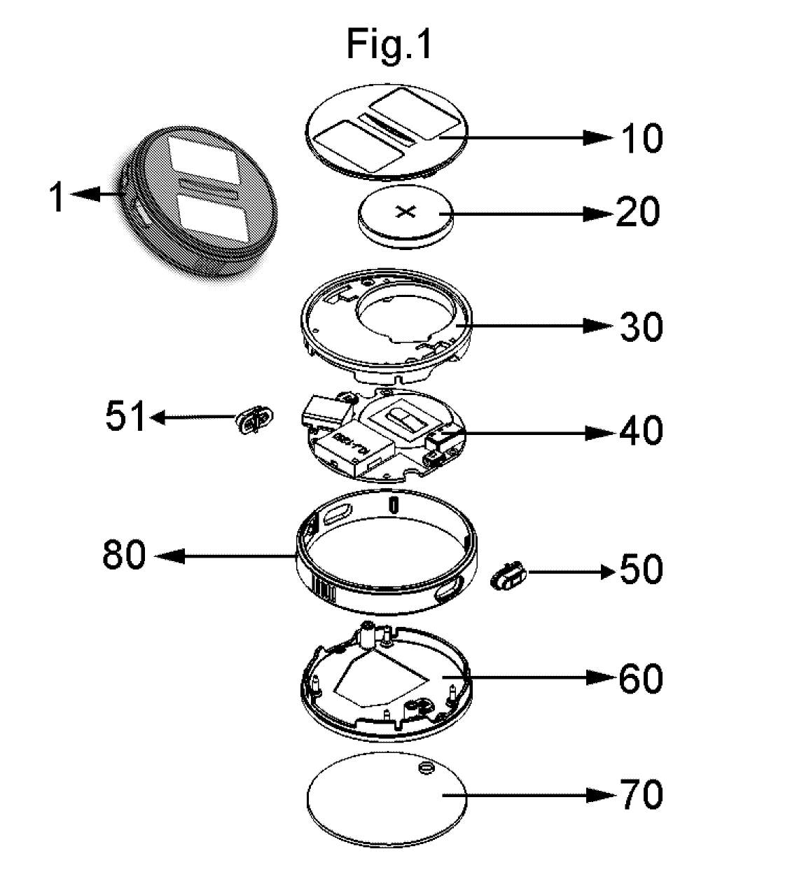

The following detailed description of the embodiments of the present invention, as represented in FIGS. 1-13, is not intended to limit the scope of the invention, as claimed, but is merely representative of the presently preferred embodiments of the invention. The presently preferred embodiments of the invention will be best understood by reference to the drawings, wherein like parts are designated by like numerals throughout.

FIG. 1 shows, in pictorial all child's sensing device parts. The child's sensing device itself 1. And the internal major components of the child are sensing device present invention. The child's sensing device battery covers 10. The child's sensing device battery 20. The child's sensing device top plastic case 30. The child's sensing device PCB 40. The child's sensing device plastic ring 80. The child's sensing device “on/off” button 50. The child's sensing device function button 51. The child's sensing device bottom plastic 60. The child's sensing device adhesive sticker or finish plastic 70. The child's sensing device adhesive sticker allows the child's sensing device to easy attached to any windows or doors.

More than one child's sensing device 1 may be utilized in implementing the system of the present invention. One child's sensing device 1 may be placed on each desired place to detect a child, as an infant in car's seat, child in mini bus seat, car driver in his seat. Or a master device as in cigarette plugs, and key fab. For example, in a car with four children, 4 children sensing devices detecting may be utilized, one for each child or infant. However, minimum one smart phone apps or master child's sensing device is necessary regardless of the number of children's sensing devices been in used. There is no limit to the number of children sensing devices which may be used with one smart phone apps. There is no limit to the number of smart phone apps, within one smart phone may be used to interact with all the children sensing devices. There is no limit to the number of smart phones that may be used to interact with child's sensing devices. Meaning that within same location, may be many smart phones getting notification from all children sensing devices simultaneously. Moreover, on every smart phone can be several apps that can use child's sensing devices notification to do parallel tasks.

Accordingly, some car's seats may be occupied with children and some without children.

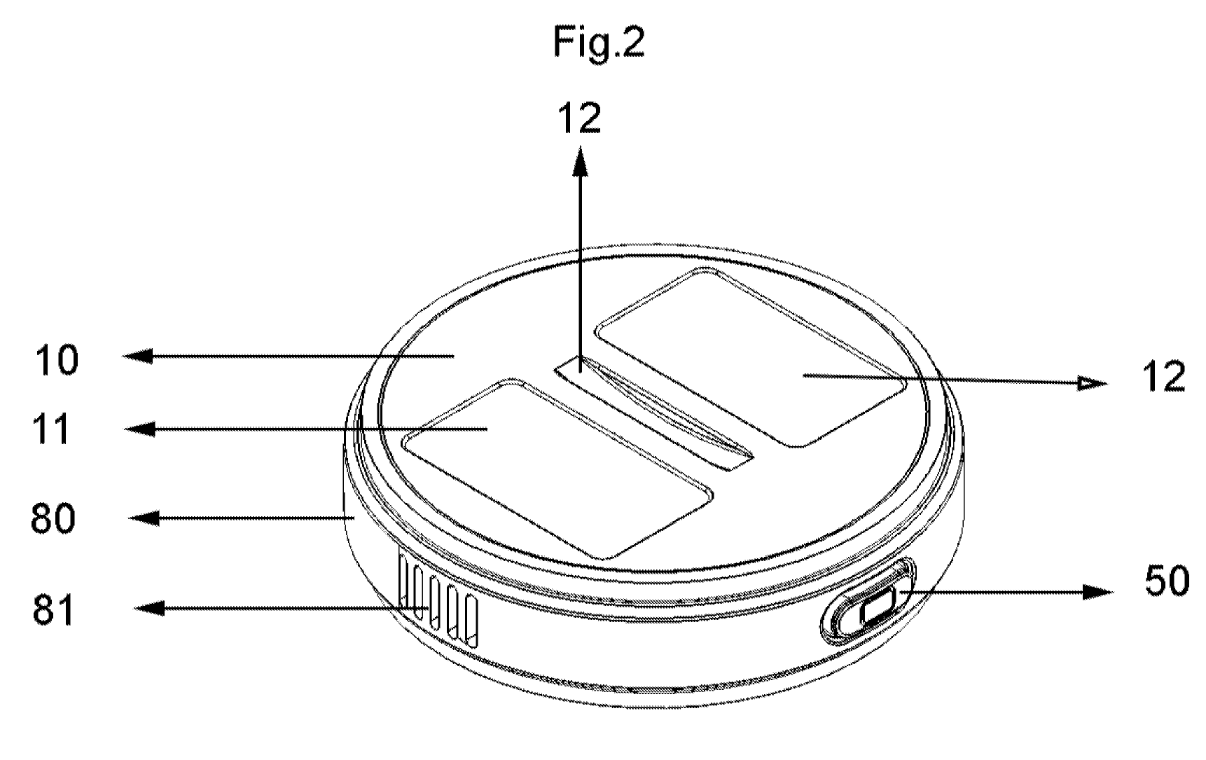

FIG. 2 shows, in pictorial all child's sensing device external parts. The child's sensing device ring 80. The ring windows 81 to let the buzzer sound out. The child's sensing device on/off button 50. The child's sensing device label 11 QR code to automatic download the smart phone apps. The child's sensing device security number 12 to secure pair with the smart phone apps. The child's sensing device QR code and the security code prevents from others' smart phone apps to control the child's sensing device. The child's sensing device battery coin open cavity 21. Child's sensing device battery cover 10. This side sticks to car seat forward to the place need to be monitored.

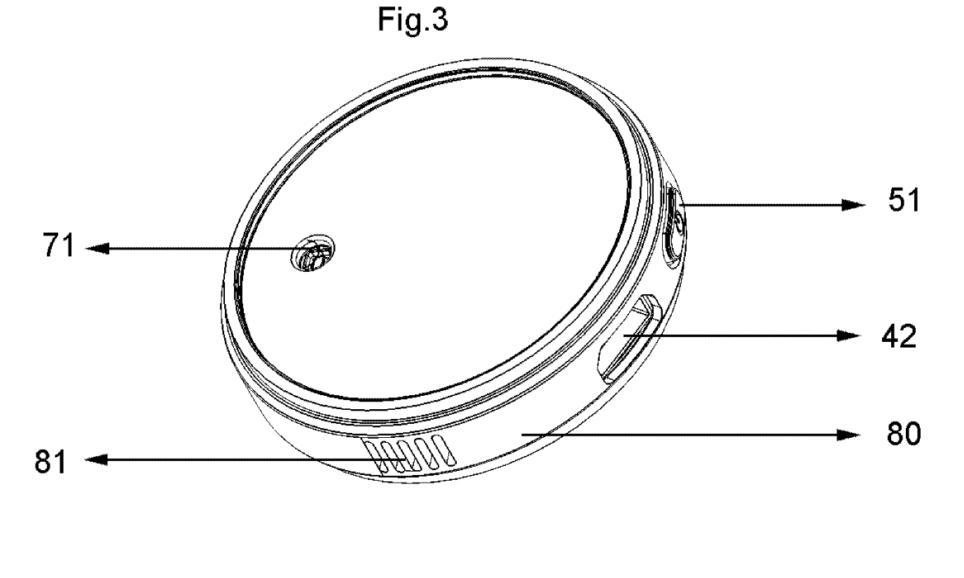

FIG. 3 shows, in pictorial all the child's sensing device front side. The button functions selector 51. This button can select different mode of operation. For example: long pressure on button 51 moves the child's sensing device to auto recognize state (or “pair”) with the smart phone apps. And add the smart phone unique identify number to a white list inside the CHILD'S SENSING DEVICE. This white list allows only the registered smart phone apps to command the child's sensing device and to get triggered command data. Connector 42 is an extension port. It allows program the devices with different firmware; add external devices over digital and analog wires. It allows power the child's sensing device from external power source, or to feed power to external devices. The child's sensing device connector 42 supports server mode of operations, digital output PIO as 3V and GND. Digital input as PIO as 3V and GND. Digital busses as I2C and UART, to connect to more possible sensors as Gyro, digital compass, smoke, fire, humidity, gas, pressure, Co2, CO, pollution, sound, light, barometric, medical devices and more alike. This connector 42 enables to send command to external devices to activate them, for example car door locker, car lights, car horn, car alarm system. Or sends and gets data from external CPU and more alike. Windows 81 allows the buzzer sound to be heard outside the child's sensing device. And 80 is the child's sensing device cover ring. The child's sensing device has an infra-red proximity distance detector sensor 71, point to infant car seat or mini bus seats. The other side of the sensor there is a sticker that sticks the child's sensing device to seat or below car windows or doors,

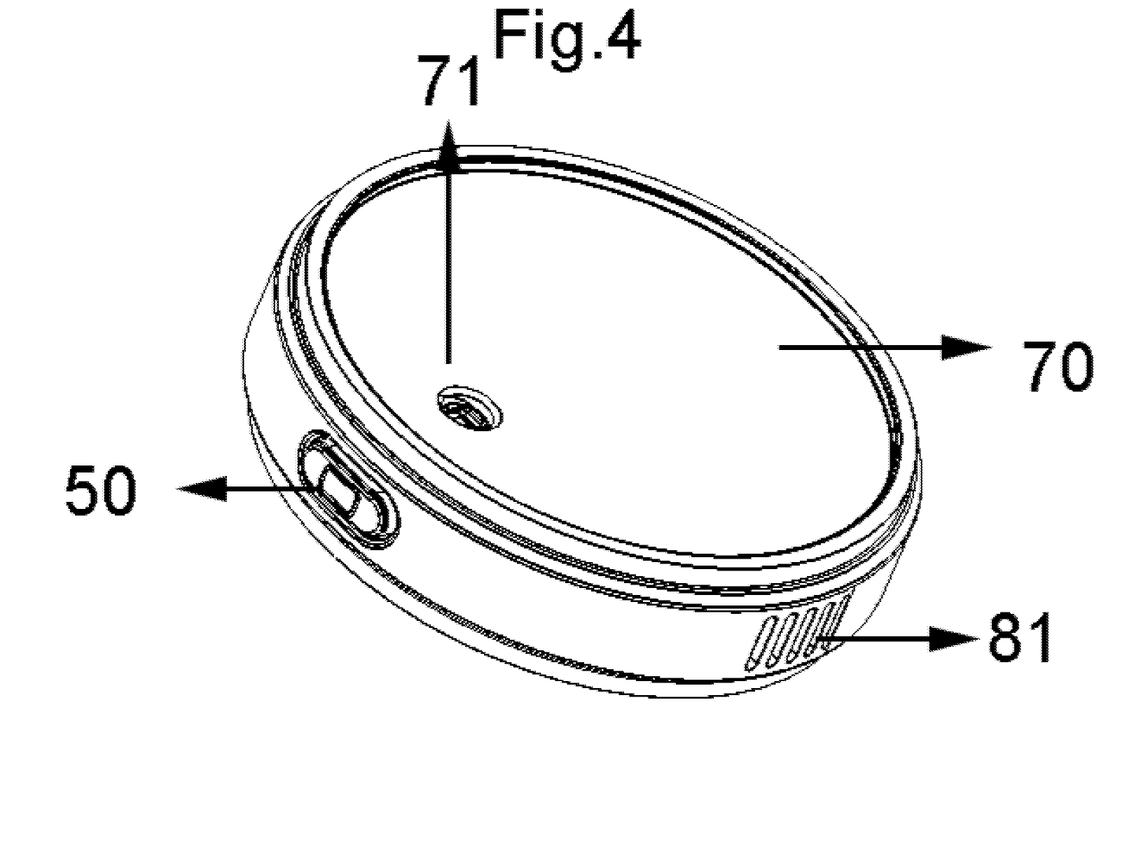

FIG. 4 shows, in pictorial all the child's sensing device front side. The child's sensing device on/off switch 50,

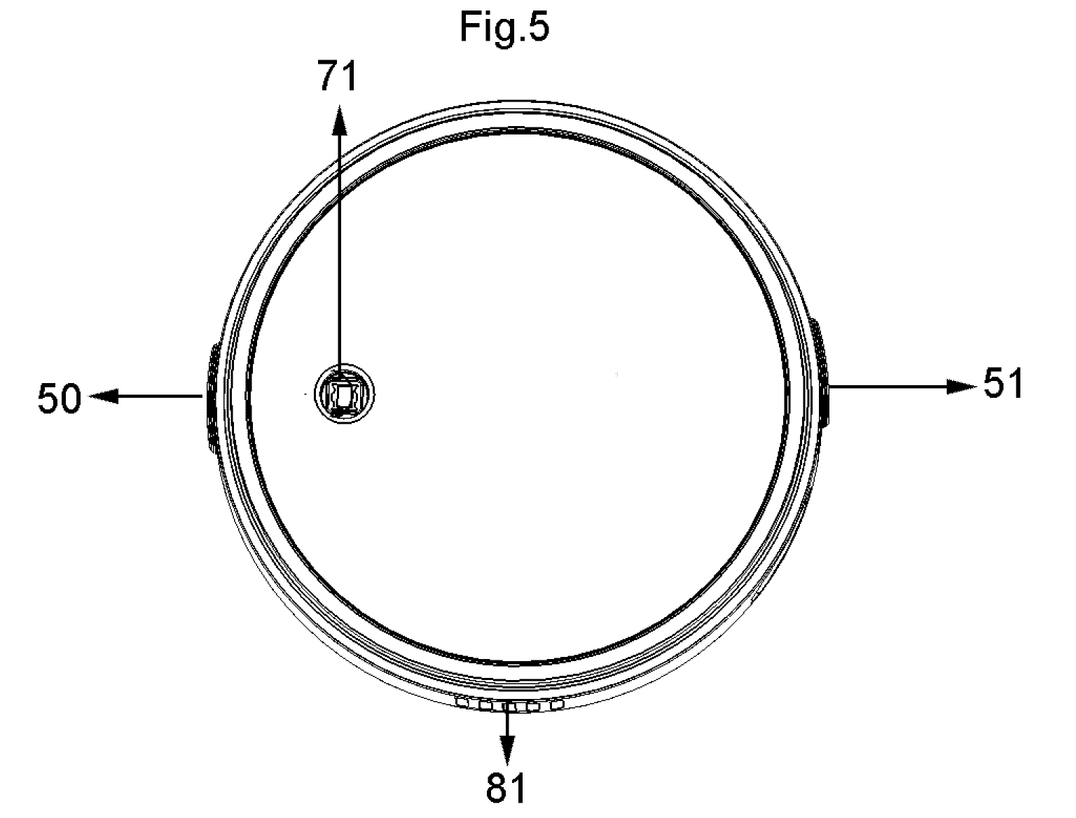

FIG. 5 shows, in pictorial the child's sensing device from front. All parts are described already in FIG. 1, 2, 3, 4.

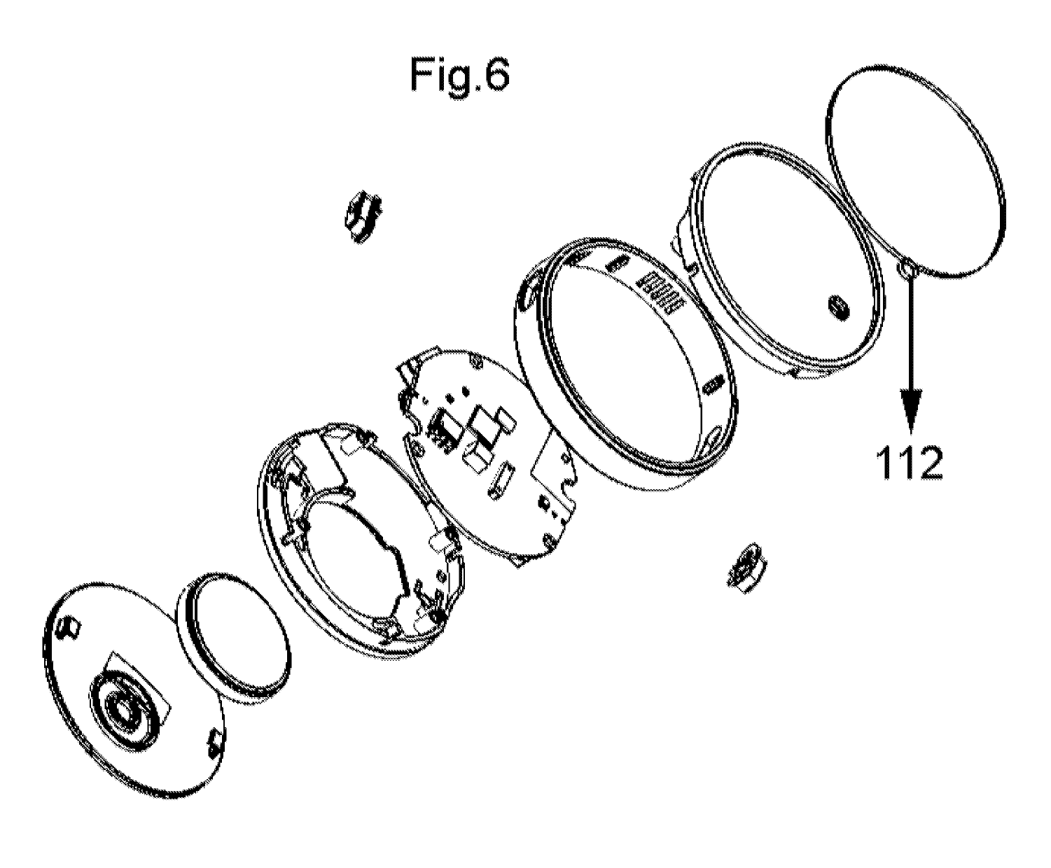

FIG. 6 shows, in pictorial the child's sensing device open with its PCB where the components side is shown. The child's sensing infra-red proximity distance detector sensor cover lens plastic hole is 112. The lens focused the infra-red proximity distance detector sensor on the target detection. Since the infra-red proximity distance detector sensor has 15 degrees opening. It is important to narrow the infra-red beam, so it can detect objects as infant and children up to 2 meters.

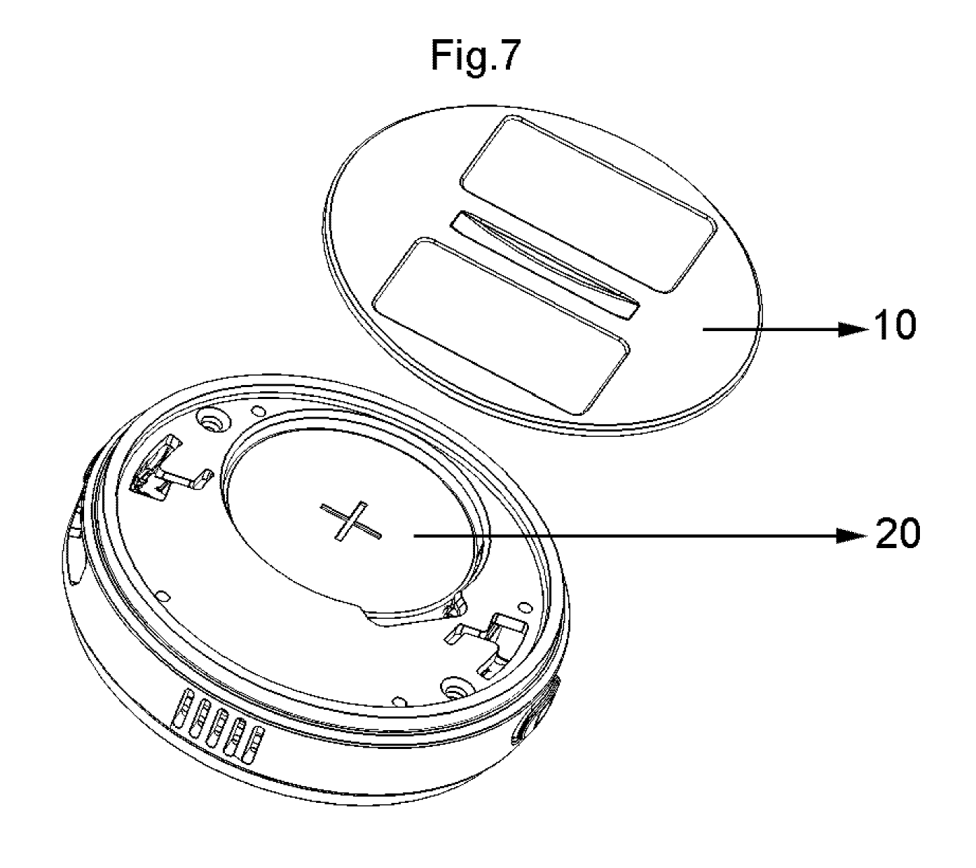

FIG. 7 shows, in pictorial the child's sensing device battery cover 10 and the place of the battery 20. The battery type is CR2032.

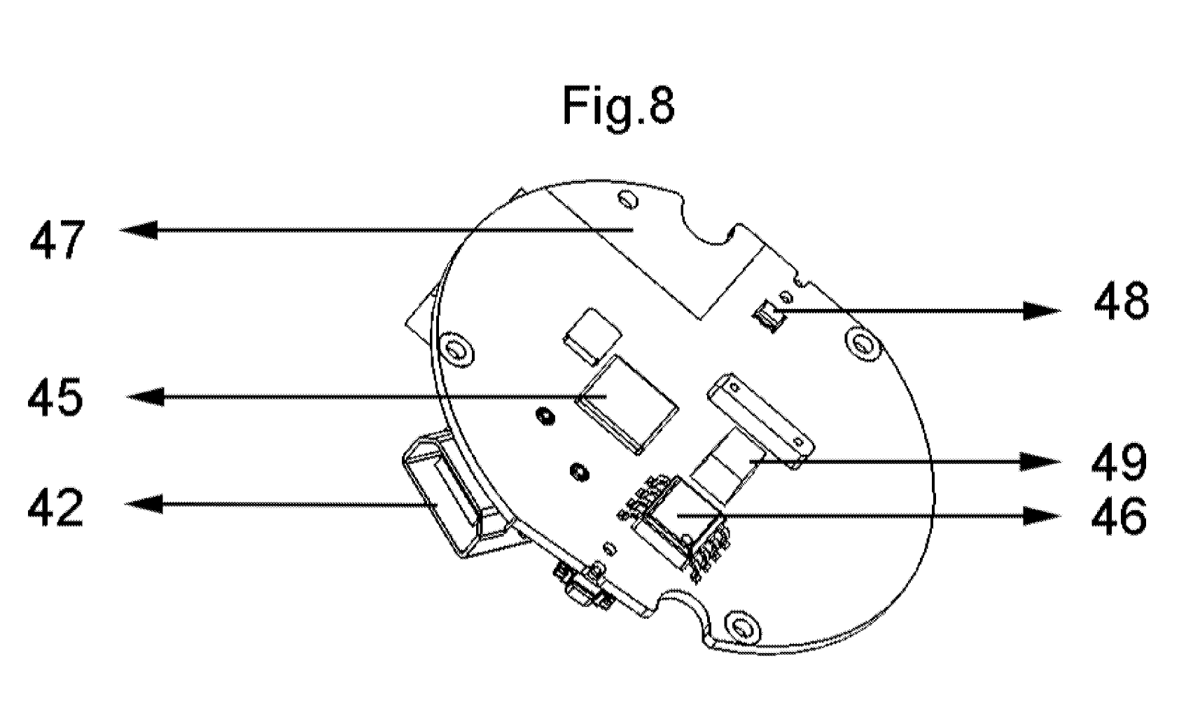

FIG. 8 shows, in pictorial the child's sensing device PCB component side. The infra-red proximity distance detector sensor 48, part number CM36770. The place of the printed antenna 47. CSR1010 child's sensing device MCU controller and RE transmitter 45 The connector 42. The child's sensing device memory AT24C512C-XHM-T 8-lead TSSOP 46. The child's sensing device triggered accelerometer MMA7660EC 49.

The present invention is not limited to this unique parts number, and any other chips with same functionality also may be used.

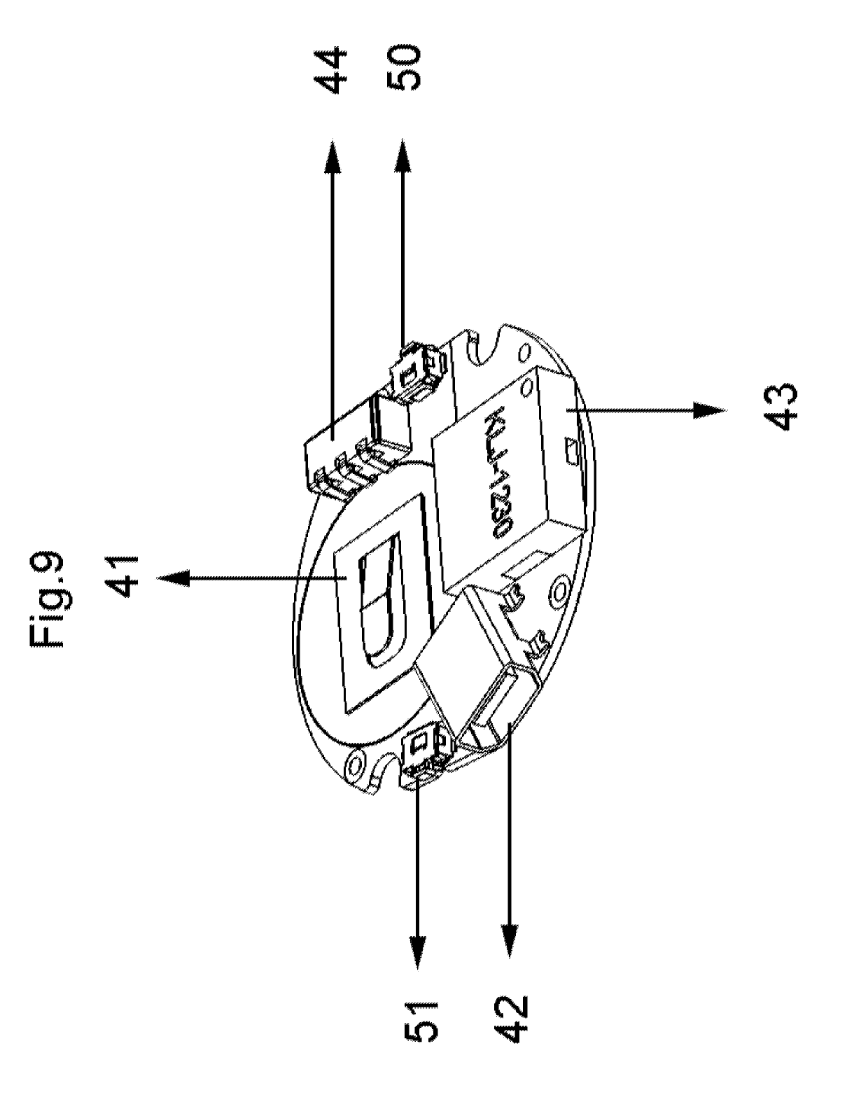

FIG. 9 shows, in pictorial the child's sensing device PCB connector side. The battery side holder 44. The child's sensing device on/off button 50. The child's sensing device buzzer 43. The child's sensing device connector 42. The child's sensing device function button 51. The battery spring holder 41.

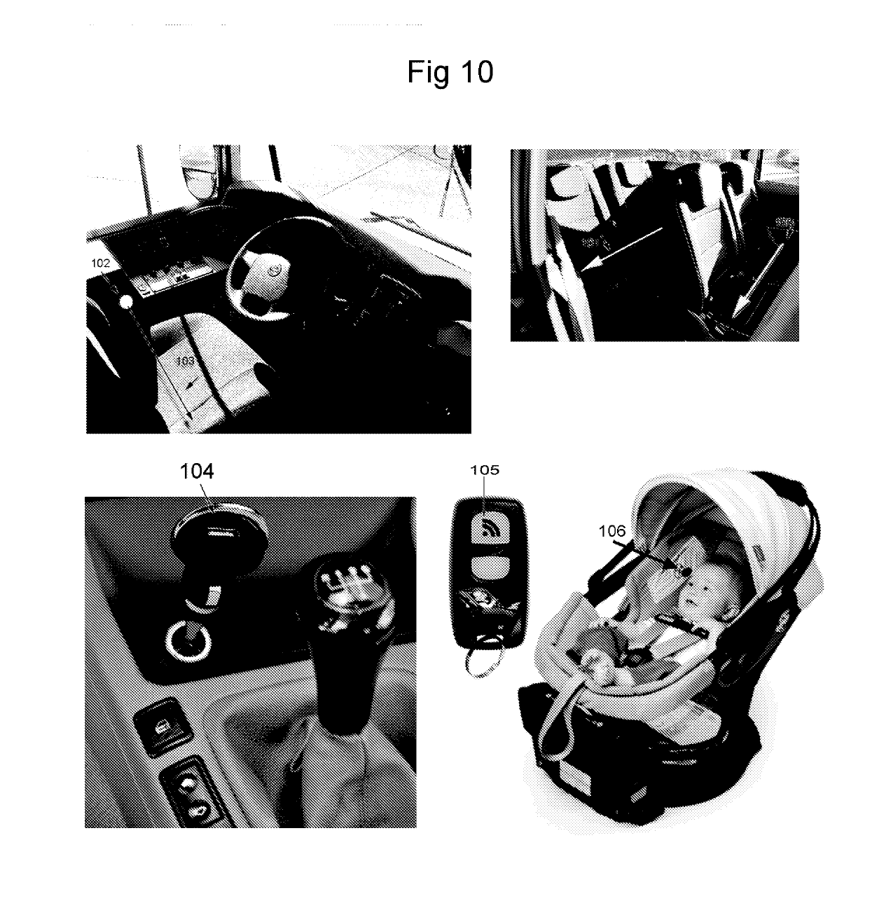

FIG. 10 shows, in pictorial a possible locating of the child's sensing device below car's windows 100. It can detect children sitting on mini bus seats. The child's sensing device detects no object on the seat as “no child on seat”. When a short distance is detected, a state is define as “child on seat” and a trigger command sent to smart phone apps. Every pair of seats will have its child's sensing device 101. Every child's sensing device has unique ID. So smart phone apps can detect which seat location there is a sleeping child.

The Baby Guardian application can be embodiment in key fab 105 and also in Baby seat 106.

If the child's sensing device detects a distance longer than bus seats the system marks that as an occupied seat.

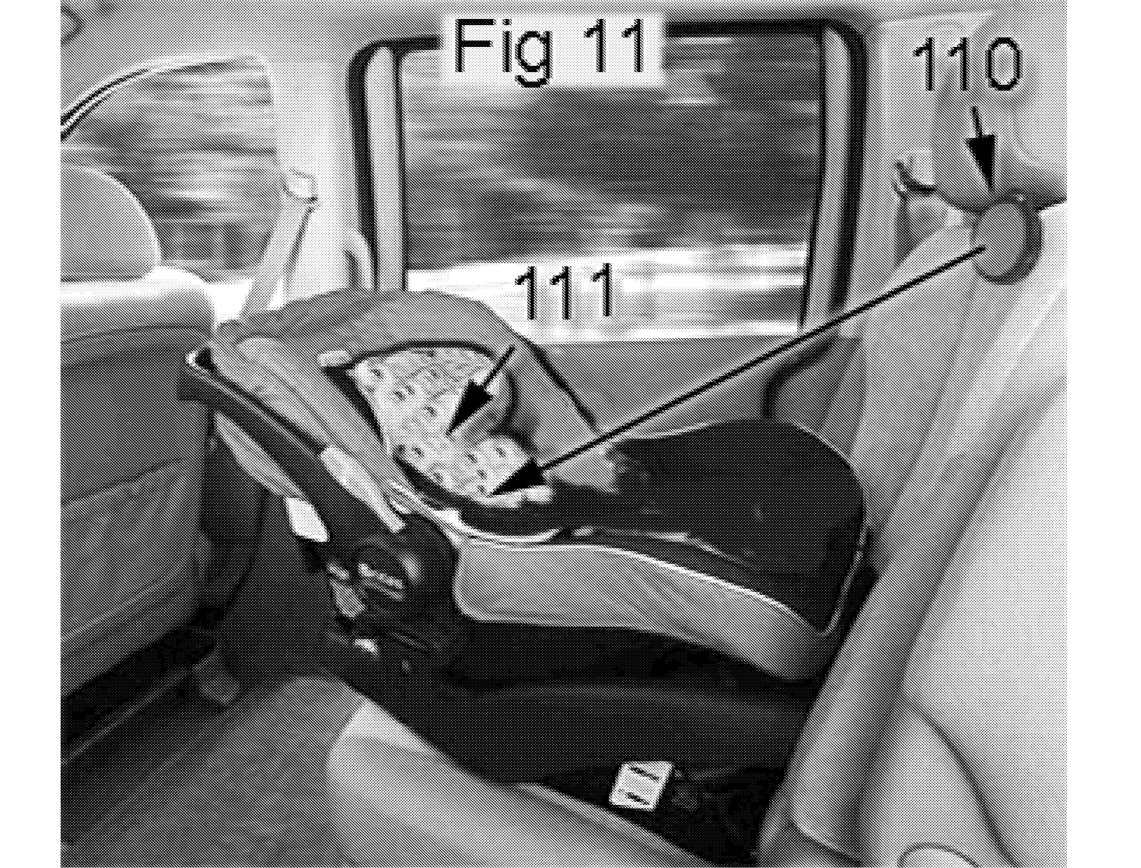

FIG. 11 shows, in pictorial a possible locating of the child's sensing device on car seat below head cushion 110. The child's sensing device infra-red proximity distance detector sensor detects the distance to empty seat 111. The distance detected when there is no child in seat is the base to detect seat occupied later.

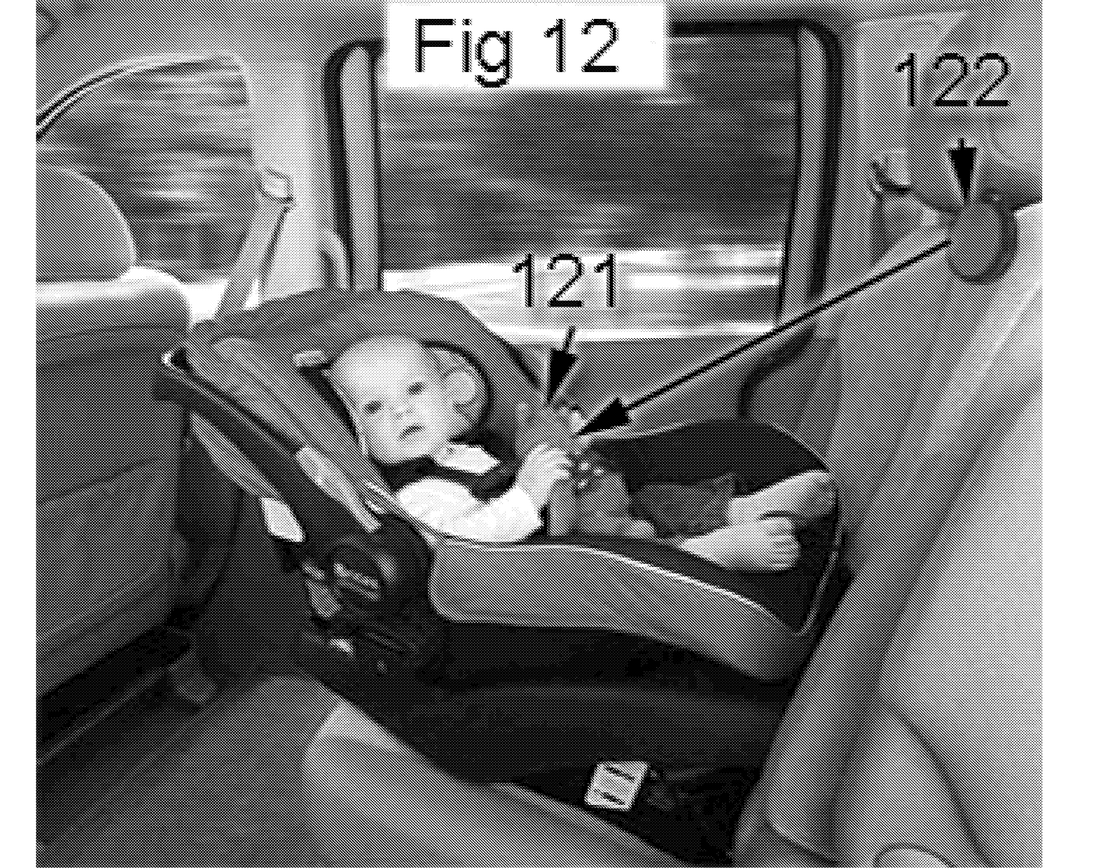

FIG. 12 shows, in pictorial a possible locating of the child's sensing device on car seat below head cushion. The child's sensing device infra-red proximity distance detector sensor detects the distance to infant occupied seat 121. When occupied seat 121 detected, a wireless message is sent to all master child's sensing devices, as smart phones, cigarette plug or key fab to automatically trigger to: “on state”/“activate”.

The distance difference between test in FIG. 11 and FIG. 12 is the base to automatically system activation or deactivation.

The child's sensing device also detects proximity to the user's master device as smart phone, therefore when the driver pulls out the child from the seat, and wireless command is sent to trigger “off” the smart phone apps or any master child's sensing device.

If the driver with any master child's sensing device walks away from the car's child's sensing device, and alarm is sound on the smart phone, reminds the driver to go back and retrieve the forgetting infant. In this alarm state, the driver can't switch off the alarm, without going hack to car, and retrieve the infant or press a key on the car child's sensing device.

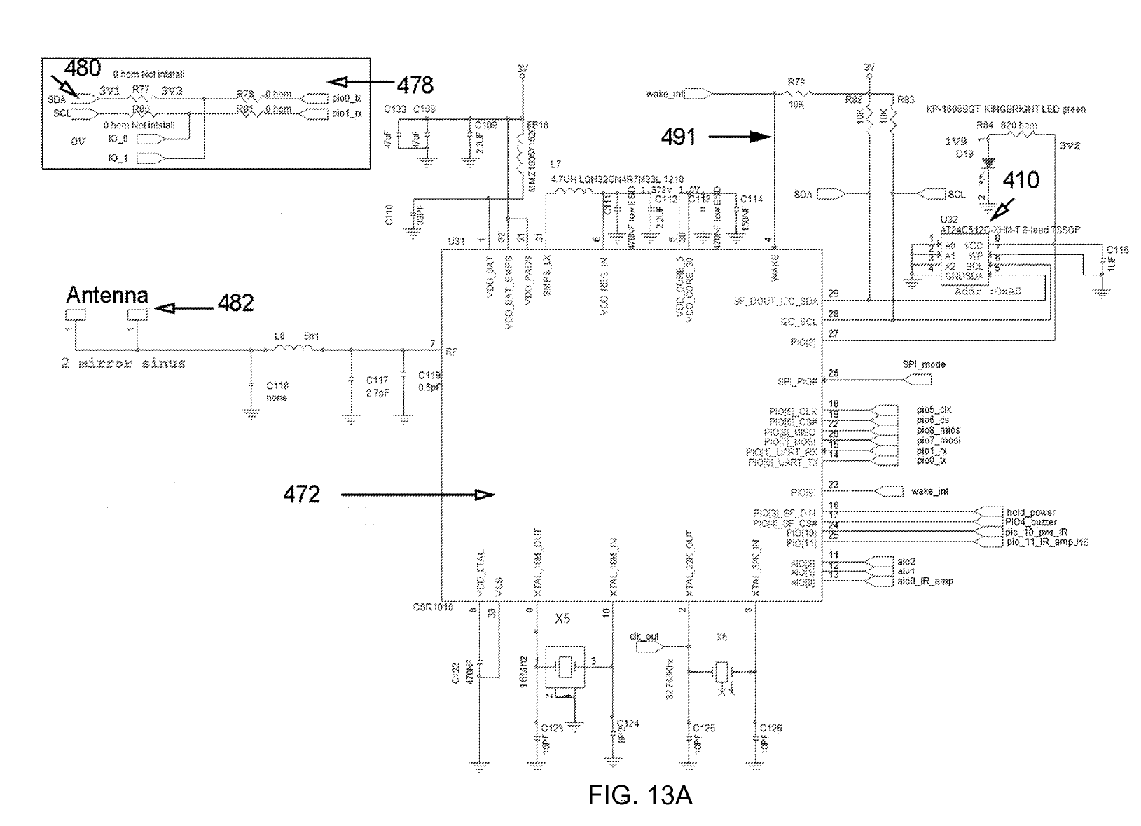

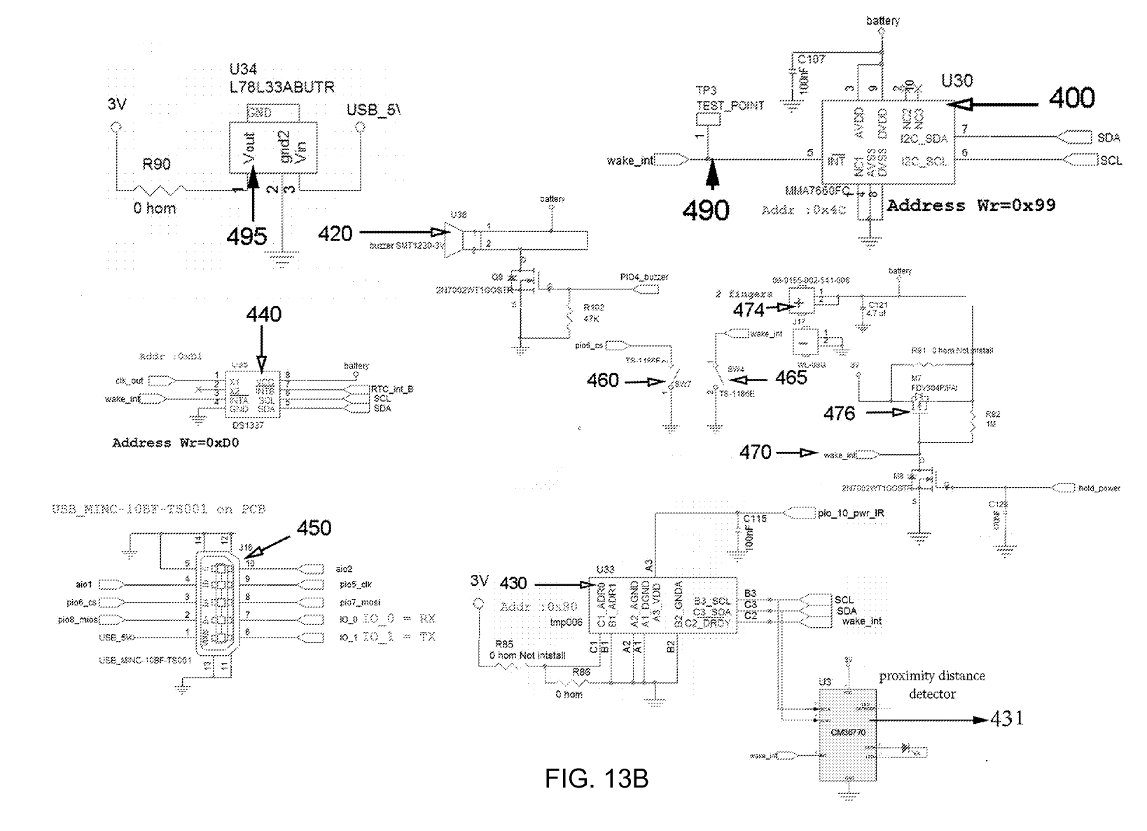

FIG. 13 shows in details the child's sensing device electric schematic diagram. The schematic is self-explanatory for enabled one skilled in the art to make and practice the invention. Several skilled in the different art fields needed to make and practice the invention. An hardware design engineer. An RF design engineer, a firmware software designer, an algorithms designer, a power supply designer for the green technologies compliant, mechanical plastic designer, and a smart phone apps designer. All components data sheet are at the public domain and easy be retrieved. The present invention does not limit itself to the present selection of the components and any other components with the same punctuality can easily be use.

The same schematics is used in the child's sensing device installed in front of the child's seat in car, in mini bus, in a driver's seat detector, in car cigarette plug or in key fab.

The child's sensing device controller 472 manufactured by CSR, with part number CSR1010. It has the processing power and the algorithm to convert the infra-red proximity distance detector sensor 431, accelerometer 400, Mma7660 from ordinary accelerations reported to triggered accelerometer, with capability to send wake_int 490 signal when the car is stop to move below defined level. The controller 472 communicates with 400 over I2C bus and with infra-red proximity distance detector sensor 431.

The child's sensing device main controller 472 is able to move by itself to low current consumption by change state to sleep mode. That happens automatically when the child's sensing device detects the car movement. Since when the car is moving the driver cannot leave the car, and there is no need to send constantly infra-red beam to detect if the infant has been pulled out of the seat. On car's stop, a wake signal from the accelerometer 400 is sent to wake the controller 472 to full active mode. This infra-red energy preservation can extend the child's sensing device battery life to several years.

The child's sensing device main controller 472 configures also internal or external real time clock 440 DS1337 over I2C to generate an 490 wake_int periodically to let The 431 child's sensing device main controller 440 test the battery of the child's sensing device level and sends a keep alive message to smart phone or any master child's sensing device.

Wake_int 490 signal is generated by Mma7660 400 and by DS1337 440 connected to point 470. Point 470 is transistor gate 476 and it switches on the power from the inner battery 474 to 3V child's sensing device bus line, 3V bus line power all parts in the child's sensing device, wake_int 490 signal connected to the child's sensing device main controller 472 wake 491 pin, which moves the controller from is sleep mode to active mode.

The child's sensing device main controller 472 has the inner capability to RE wirelessly transmit and receive the signal to the smart phone using the antenna 482.

The child's sensing device main controller 472 utilizes the connector 450 to sense external sensor on I2C bus 480 and on UART bus 478.

The child's sensing device has a remote infrared temperature sensing chip 430, part number tmp006. This chip can detect any nearby human body temperature. It is located on the PCB front side of the child's sensing device, facing outside of the attached windows. The 430 temperature sensing chip is programmed by controllers 472, over I2C, to generate a wake_int 490 signal on triggered level on its infrared temperature sensing.

The child's sensing device has a button 461 FIG. 151. It is a tact switch. The user can select mode of operation by pressing it. The pattern on long and short time press defines the command to the child's sensing device main controller 472.

The button 465 FIG. 150. It is the child's sensing device on/off switch. Since the controller 472 moves itself to sleep automatically, this button 465 is the button wake-up child's sensing device by sending wake_int 490 signal when pressed.

The child's sensing device buzzer 420, it sounds when 472 controllers activate it. The activation is per smart phone apps command or self-activation where there is no smart phone wireless link.

The child's sensing device flash memory 410 is the controller 472 memory storage. It stores the controller 472 main application and all data and setting of the child's sensing device. Flash memory 410 powers itself from controller 472 PIO2. When the controller 472 is in a sleep mode, the PIO2 is low, and there is no power wasted on power feed to the flash memory 410.

Another example of occupant sensor includes a visual or other electromagnetic radiation detector, such as a camera. Examples are found in U.S. Pat. No. 6,198,998; U.S. Pat. No. 5,983,147; U.S. Pat. No. 6,005,958, each of which is incorporated by reference in its entirety. The camera may be mounted in a number of different positions in the vehicle, such as over the front wind shield or on the roof. See, e.g., U.S. Pat. No. 6,014,602, which is incorporated by reference herein in its entirety. Another example occupant sensor 200 includes an ultrasound transmitter and/or receiver. See, e.g., U.S. Pat. No. 6,029,105, which is incorporated by reference herein in its entirety. Another example of occupant sensor 200 includes an electromagnetic field sensor. See, e.g., U.S. Pat. No. 5,605,348, which is incorporated by reference herein in its entirety. Other types of transmitter and/or receiver sensor(s) are also included. See, e.g., U.S. Pat. No. 5,802,479, which is incorporated herein by reference in its entirety. Moreover, a combination of the above sensors or other sensors can be used to implement occupant sensor 200. See, e.g., U.S. Pat. No. 6,026,340, which discusses a combination infrared and ultrasound sensor as a multi-sensor and a combination thermal and acoustic sensor, and which is incorporated herein by reference in its entirety.

Examples of remote child's sensing device, vehicle wireless transceiver, and associated vehicle components to which vehicle transceiver interfaces, are discussed in U.S. Pat. No. 5,600,302, U.S. Pat. No. 6,236,333, and U.S. Pat. No. 6,259,362, each of which is incorporated by reference herein in its entirety.

While the above examples have treated the particular problem of leaving a child behind in an infant seat, it is understood that these techniques are equally applicable to sense and warn whether any occupant (e.g., driver or other passengers) has been left behind in a vehicle seat, which need not be a child seat. Moreover, the terms infant seat and child seat in this document include child booster seats for older children. Furthermore, the infant, child, or booster seats referred to herein need not be limited to removable seats, but also include such seats that are built in to the vehicle itself, including such seats that are also capable of seating an adult.

It is to be understood that the above description is intended to be illustrative, and not restrictive. For example, the above-discussed embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

The child's sensing device firmware core stack, specifies device roles, modes and procedures for the discovery of devices and services, the management of connection establishment and security. The child's sensing device defines four roles with specific requirements on the underlying controller:

Broadcaster, Observer, Peripheral and Central. A device in the Broadcaster role only broadcasts data (via the advertising channels) and does not support connections with other devices.

The Observer role is complementary for the Broadcaster, i.e., it has the purpose of receiving the data transmitted by the Broadcaster. The Central role is designed for a device that is in charge of initiating and managing multiple connections, whereas the Peripheral role is designed for simple child's sensing device which uses a single connection with a device in the Central role. In consequence, the Central and Peripheral roles require that the child's sensing device's controller supports the master and slave roles, respectively. A device may support various roles, but most of the time one role is adopted at a given time.

Finally, since certain types of applications may benefit from reusing common functionality, additional profiles can be built on top of the child's sensing device core. Core follows a profile hierarchy, whereby a new profile including all the requirements of an existing profile can be defined. A highest-level profile that specifies how applications can interoperate is called: “an application profile”. Application

Profiles, which are also specified by the child's sensing device core, favor interoperability between devices from different manufacturers.

Observer Broadcaster

Child's sensing device comes with two main profiles:

Broadcaster:

as child seat device in front of an infant's car seat (FIG. 12 122)

as child's sensing device below window at bus or minibus (FIG. 10 100) (FIG. 10 101)

as sensor in front of the driver seat (FIG. 10 102), toward (FIG. 10 103)

Observer:

Car Driver or Car passengers smart phone with Baby Guardian application

A key fab with child's sensing device electronics embedded inside (FIG. 10 105)

A car cigarette plug charged with child's sensing device embedded inside (FIG. 10 104).

Mode of Operation:

Any Broadcaster can become Observer upon detecting the complementary other side. That is accomplished by momentary switch to central mode.

All Broadcaster devices will auto learn the distance when there is no object in front: No infant in car seat, no child in bus seat, no driver in car seat. The pre-setting is stored inside the child's sensing device inner flash.

When child's sensing device infra-red proximity distance detector sensor, detects an object, it broadcaster a wireless message with its ID, profile, and battery level.

A complementary child's sensing device, in Observer mode, detects the wireless message and automatically triggers itself to “ON” monitored mode.

Detection modes may include:

A—Upon removing the infant from car's seat, the child's sensing device broadcaster a wireless message to automatically trigger an observer device to “OFF” state from its monitored mode.

Upon child leave the bus seat, the child's sensing device broadcaster a wireless message to automatically trigger observer devices to “OFF” state from its monitored mode.

Upon driver leave driver car seat, the driver child's sensing device starts to beep an alarm sound, to alert that child is left behind in one of the bus seats.

Upon driver turns off the car engine switch, the car cigarette plug, gets no car power, and the child's sensing device inside the cigarette car plug charger starts to beep an alarm sound, to alert that child is left behind in one of the bus's seat or an infant in private car seat. The plug (FIG. 10 104) has super cap (as small battery) to maintain power for the alarm after car's power is switched “off”. It has also the ability to play a voice message over its internal speaker. The voice message can be stored inside the plug.

When the car's driver leaves the car and abandon a child behind in an infant/child seat, his smart phone, running the Baby Guardian application will automatically start to sound an alert. The alert will be sound also when the phone is on a silent state. There will be no option to close the alert without the driver returning to that car and press a key on the button of child's sensing device. The distance is monitored by RSSI from smart phone to child's sensing device. The Baby guardian application will send, in this alert state, an automatic electronic message by SMS, email or/and a phone call with pre-recorded voice message. If the driver does not react in pre define time, the urgent message may be sent police 911 as a phone call or SMS to the police with GPS marked car location and the caretaker phone number.

When the car's driver leaves the car and abandon a child behind in an infant/child seat, his key fab with child's sensing device inside it, will start to sound an alert. There will be no option to close the alert without returning to that car and press a key on the button of child's sensing device. The distance is monitored by RSSI from key fab to the car's child's sensing device.

When the car child's sensing device detects battery low level, it broadcasts a unique message to replace the battery within the next 2 months.

When the car's child's sensing device detects a high temperature it broadcasts a unique message to checked the infant in the car seat.

From time to time Broadcaster, Observer switch sides/states when on an “active mode”. In this way the car's child's sensing device detects if the “Observer” is still alive. Meaning, that the smart phone did not run out of battery. If the car's child's sensing device detects no “Observer” it starts to alert.

Other embedment of the invention may include having the child's sensing device installed inside a carry infant seat (FIG. 10 106). And with the care taker's smart phone Baby Guardian application, or key-fab, it reduces the likelihood of leaving an unattended child behind in an infant/child seat in a vehicle or any other places. It becomes as an electronic leash.

Other embedment of the invention may include having the child's sensing device installed inside an infant trolley seat. And with the care taker's smart phone Baby Guardian application, or key fab, it reduces the likelihood of leaving an unattended child behind in an infant/child seat in a vehicle or any other places. It becomes as an electronic leash.

Other embedment of the invention may include having the child's sensing observer device installed as an integral part of the car or bus. In this embodiment of the patent, it can hook also to car alarm, car computer to automatically open car doors and windows, or using car anti-theft cellular system, and can report an alarm state over this wireless channel.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A monitor for detecting a potential abandonment of an infant in a seat of car; the monitor comprises: a distance sensor that is configured to detect a distance between the distance sensor and a target; wherein the target is the seat of the car when the infant is not seated in the seat; wherein the target is the infant when the infant is seated in the seat; and a controller that is configured to (a) receive, from the distance sensor, distance information about the distance between the distance monitor and the target, (b) receive potential departure information indicative of a potential departure, from the car, of a driver of the car; (c) determine, in response to the distance information and the potential departure information, whether the potential abandonment occurred; and (d) response to the determining of whether the potential abandonment occurred.

2. The monitor according to claim 1 wherein the distance sensor comprises an infrared transmitter that is configured to transmit modulated infrared pulses towards the seat of the car and an infrared receiver that is configured to receive infrared signals from the target.

3. The monitor according to claim 1 wherein the potential departure information is indicative of a power shut down of the car.

4. The monitor according to claim 1 wherein the potential departure information is location information that is indicative of a location of the driver.

5. The monitor according to claim 1 wherein the potential departure information is provided by a driver seat sensor and is indicative of a departure of a driver from the driver seat.

6. The monitor according to claim 1 comprising a battery and a battery sensor that is configured to sense a state of the battery.

7. The monitor according to claim 1 wherein the transceiver is configured to transmit to a user device an activation message that once received by the user device activates a child monitoring application.

8. The monitor according to claim 7 wherein the controller is arranged to respond to an occurrence of the potential abandonment by sending an alert to the user device.

9. The monitor according to claim 1 wherein the controller is arranged to respond to an occurrence of the potential abandonment by sending an alert to the user device and to a remote party.

10. The monitor according to claim 1 wherein the controller is arranged to monitor a state of communication between the monitor and a user device and to generate an alert when the communication breaks.

11. The monitor according to claim 1 comprising a housing and a code that once retrieved by a user device causes the user device to a download a child monitor application.

12. The monitor according to claim 1 wherein the transceiver is configured to operate at a broadcast mode during which the transceiver periodically transmits status information that reflect the determining of whether the potential abandonment occurred; wherein the status information once received by a user device activates a child monitoring application, wherein the activation of the child monitoring application is executed even if the user device did not pair with the monitor.

13. A system for detecting a potential abandonment of an infant in a seat of car, wherein the system comprising a monitor and at least one additional sensor;
wherein the monitor comprises: a distance sensor that is configured to detect a distance between the distance sensor and a target; wherein the target is the seat of the car when the infant is not seated in the seat; wherein the target is the infant when the infant is seated in the seat; and a controller that is configured to (a) receive, from the distance sensor, distance information about the distance between the distance monitor and the target, (b) receive potential departure information indicative of a potential departure, from the car, of a driver of the car; (c) determine, in response to the distance information and the potential departure information, whether the potential abandonment occurred; and (d) response to the determining of whether the potential abandonment occurred;
wherein the at least one additional sensor is selected of a group consisting of (a) a car power sensor that is configured to detect a shutdown of the car; and (b) a driver seat sensor that is configured to detect whether a driver sits in the driver seat.

14. The system according to claim 13 wherein the car power sensor is plugged in a cigarette plug of the car.

15. A method for detecting a potential abandonment of an infant in a seat of car; the method comprises: detecting, by a distance sensor, a distance between the distance sensor and a target; wherein the target is the seat of the car when the infant is not seated in the seat; wherein the target is the infant when the infant is seated in the seat; receiving, by a controller distance information about the distance between the distance monitor and the target; receiving, by the controller, potential departure information indicative of a potential departure, from the car, of a driver of the car; determining, by the controller and in response to the distance information and the potential departure information, whether the potential abandonment occurred; and (d) responding to the determining of whether the potential abandonment occurred.
